(19) United States
(12) Patent Application Publication
(10) Pub. No.: US 2015/0143788 A1
(43) Pub. Date: May 28, 2015

(54) HARDFACED BED KNIFE

(71) Applicant: Fisher Barton Specialty Products, Inc., Watertown, WI (US)

(72) Inventors: Brandon Cary Rose, Oconomowoc, WI (US); Daniel F. Duffek, Watertown, WI (US)

(73) Assignee: Fisher Barton Specialty Products, Inc., Watertown, WI (US)

(21) Appl. No.: 14/087,509

(22) Filed: Nov. 22, 2013

(51) Int. Cl. A01D 34/01; A01D 34/52

(52) U.S. Cl. CPC A01D 34/015; A01D 34/52
USPC 56/251; 29/891

(57) ABSTRACT

A bed knife adapted to be coupled with a reel cutting unit for cutting grass is oriented with respect to a rotating cutting reel of the reel cutting unit. The bed knife includes a body formed from a first material and a cutting portion formed from a second material. The second material is different from the first material, and the second material is deposited onto the body by a welding process.

### BACKGROUND

The present invention relates to a reel mower having a reel cutting unit. More particularly, this invention relates to a bed knife used on the reel cutting unit.

### SUMMARY

In one embodiment, the invention provides a bed knife adapted to be coupled with a reel cutting unit for cutting grass oriented with respect to a rotating cutting reel of the reel cutting unit. The bed knife includes a body formed from a first material and a cutting portion formed from a second material. The second material is different from the first material and the second material is deposited onto the body by a welding process.

In another embodiment the invention provides a method of manufacturing a bed knife adapted to be coupled with a reel cutting unit for cutting grass oriented with respect to a rotating cutting reel of the reel cutting unit. The method includes providing a sheet formed from a first material, depositing a second material onto the first material by a welding process, and machining away portions of the first material and the second material.

Other aspects of the invention will become apparent by consideration of the detailed description and accompanying drawings.

### BRIEF DESCRIPTION OF THE DRAWINGS

FIG. 1 illustrates a reel cutting unit including a bed knife for use in a reel mower.

FIG. 2A illustrates a first step in manufacturing the bed knife of FIG. 1.

FIG. 2B illustrates a second step in manufacturing the bed knife of FIG. 1.

FIG. 2C illustrates a third step in manufacturing the bed knife of FIG. 1.

FIG. 2D illustrates a fourth step in manufacturing the bed knife of FIG. 1.

FIG. 3 illustrates a partial cross-sectional view of the completed third step of FIG. 2C shown in phantom, with two bed knives of FIG. 1 shown in solid lines.

FIG. 4 illustrates a cross-sectional view of the bed knife of FIG. 1 with half of the original material from FIG. 2A shown in phantom.

FIG. 5 illustrates a cross-sectional view of the bed knife of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

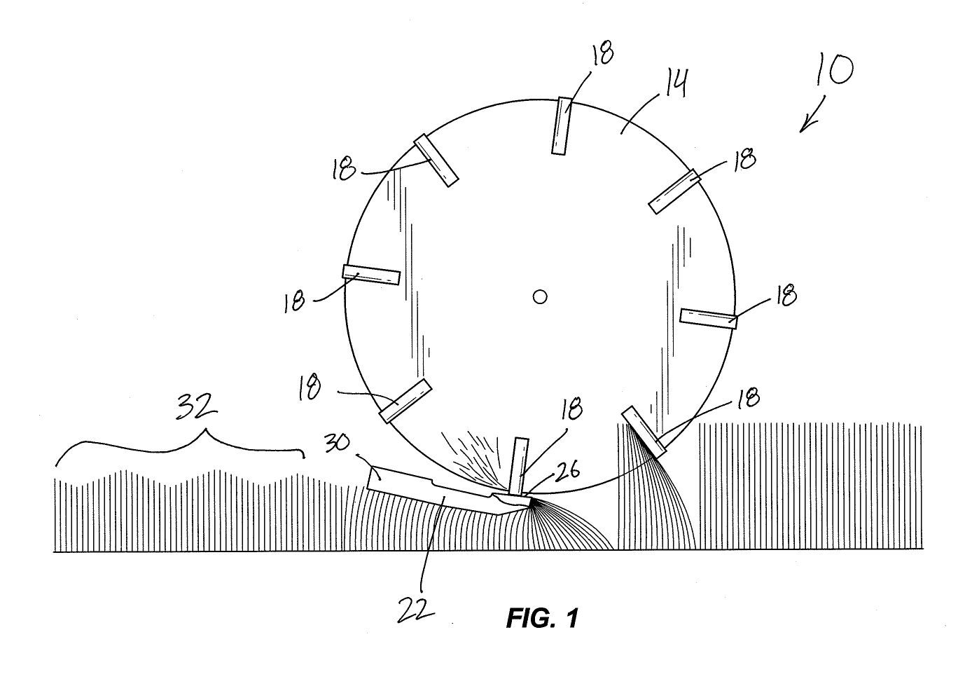

With reference to FIG. 1, a reel cutting unit 10 includes a reel 14 with a plurality of blades 18, and a stationary bed knife 22. The reel 14 is driven to rotate the blades 18 such that grass is pushed against a cutting surface 26 of the bed knife 22 by the blades 18. The grass is sheared between the cutting surface 26 of the bed knife 22 and the blades 18 of the reel 14. The bed knife 22 includes a mounting portion 30 to operatively orient the bed knife 22 in relation to the blades 18 of the reel 14. As the cut grass exits the reel cutting unit 10, the shape is a uniform weave 32, as illustrated in FIG. 1 behind the bed knife 22. The manufacture of the bed knife 22, and the bed knife geometry and composition are discussed in detail below.

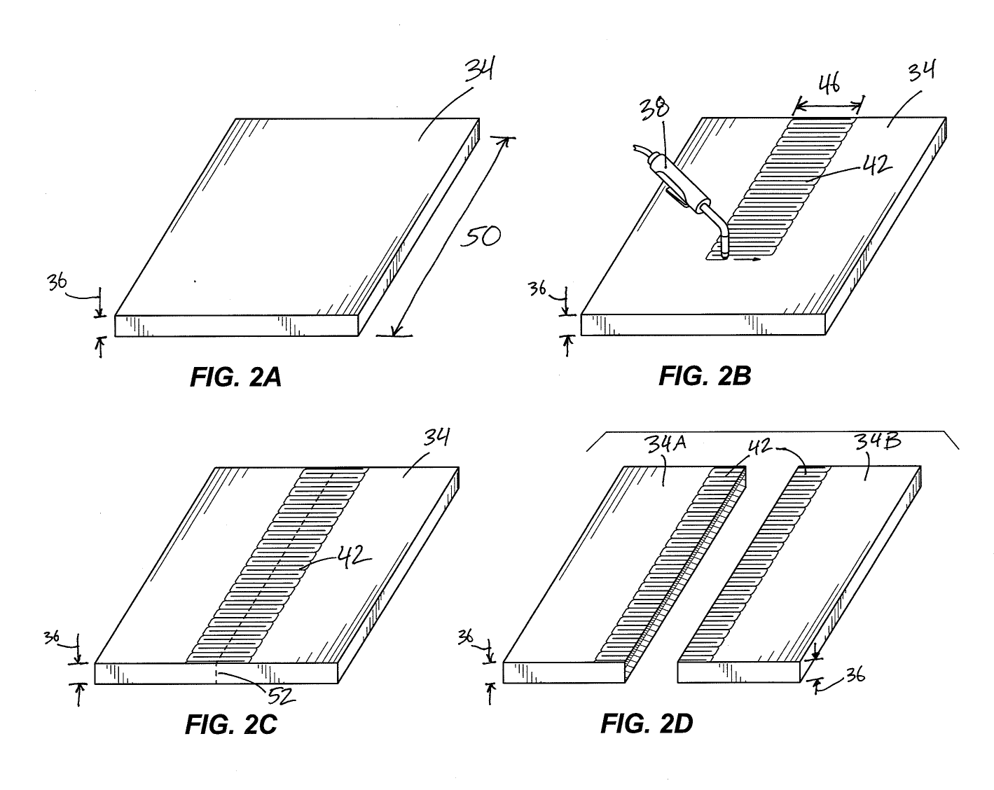

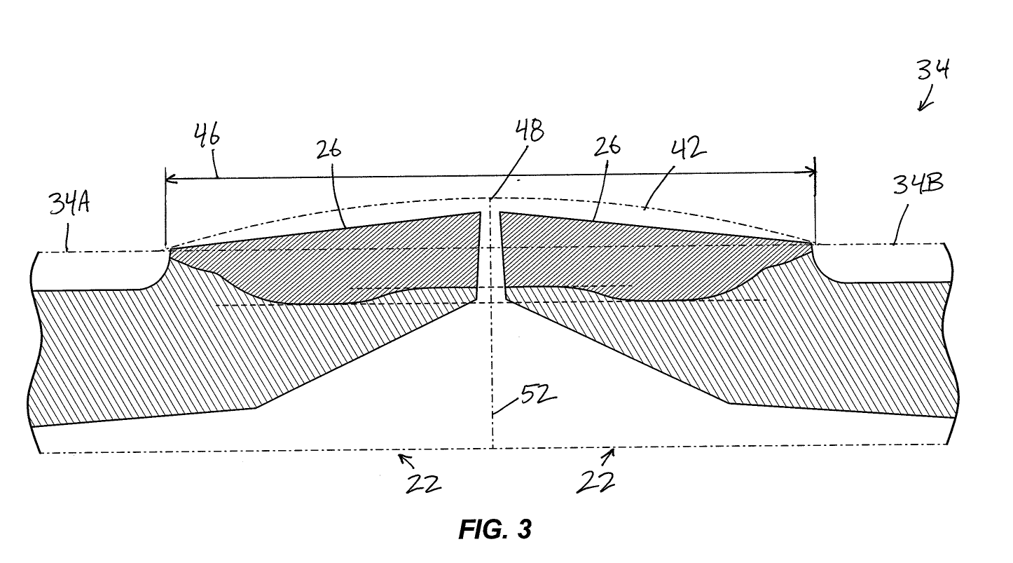

With references to FIGS. 2A-2D, steps of a manufacturing process to make the bed knife 22 are illustrated. To begin, as shown in FIG. 2A, a solid sheet 34 made from a first material is provided. The first material may be, for example, preheated as-rolled steel. The sheet 34 has a thickness 36 between about 4 mm to 6 mm, as is appropriate for bed knife applications. Next, referring to FIG. 2B, a welding process is performed on the sheet 34. The welding process deposits a second material (i.e., a hardfacing material) on the sheet 34 with a welder 38. The second material is harder than the first material. The second material may be, for example, an iron-based steel alloy powder. In other embodiments, the second material may be a tungsten carbide nickel based powder. The wide range of commercially available hardfacing powders allow for the selection of lower cost raw materials with superior wear resistance.

The welding process may be, for example, a plasma-transferred-arc (PTA) welding process. The second material is fed at a rate of, for example, 10 grams per minute, and the welding current range is approximately 80-125 Amps. The welding process joins the second material to the first material without the need for brazing, and allows for precise control of the geometry of the second material as it is deposited onto the first material. The welder 38 is controlled to travel in a continuous weave pattern during the welding process. The second material is deposited in a weld bead 42 having a width 46 of, for example, 16 mm. The speed at which the welder 38 travels along a length 50 of the sheet 34 is, for example, 1 mm per second. The speed at which the welder 38 travels along the width 46 of the bead 42 is variable since the welder 38 has to slow down to change directions when weaving back and forth.

With continued reference to FIG. 2B, since the welder 38 is controlled to move in a weave pattern, the welder slows down to change directions and, as a result, spends more time at the edges of the weld bead 42 (i.e., the ends of the weld bead width 46). With the welder 38 spending an increased amount of time at certain locations, the dilution depth (i.e., the depth to which the second material penetrates the first material) increases. Thus, the welder 38 is controlled to create a weave pattern resulting in a varied dilution depth of the second material across the weld width 46. As a result, the amount of second material deposited on to the first material and the depth at which the second material penetrates the first material are determined by the welding process control, and more specifically, the welder 38 speed.

In alternative embodiments, the welding process may be a Laser-Cladding welding process. In the Laser-Cladding welding process, the welder is controlled to lay a plurality of parallel weld beads (also known as “stringer beads” or “overlays”) along the length 50 of the sheet 34. Each one of the weld beads is laid by the Laser-Cladding welding process individually, with the welder always starting a new weld bead at the same end of the sheet 34 (i.e., a discontinuous process). The Laser-Cladding welding process can also control the welder to lay a continuous weave pattern similar to that described above with respect to the PTA welding process. The Laser-Cladding welding process changes the power and intensity of the laser to achieve different dilution depths of the second material into the first material. The Laser-Cladding welding process has a lower heat input than the Plasma-Transferred-Arc welding process, and results in a smaller heat-affected-zone.

With reference to FIG. 2C, the welding process is complete and the second material is deposited on the first material all along the length 50 of the sheet 34. Following the welding process, the steel sheet 34 is slowly cooled in a furnace (not shown) to prevent distortion and cracking With reference to FIG. 3, the weld bead 42 after completion of the welding process is shown in phantom with the final bed knife 22 geometry illustrated in solid lines. The weld bead 42 includes a crown 48 positioned at the highest point along the width 46 of the weld bead 42 with respect to the sheet 34. The weld bead 42 extends across two halves 34A, 34B of the sheet 34.

Referring to FIG. 2D, the sheet 34 is then separated into two halves 34A, 34 B by a cutting process, with each half being used to form a bed knife (i.e., sheet 34 produces two complete bed knives 22). The sheet 34 is cut down a middle line 52 through the crown 48 of the weld bead 42 laid by the welding process. The cutting process cuts through the sheet 34 at a location containing both the first material and the second material. The cutting process may be, for example, a water jet cutter. Forming two bed knives from a single sheet 34 is cost effective due in part to the crown 48 that is naturally formed during the welding process described above. That crown 48 serves as a natural high-point for the two leading edges 62 formed by the cut along the middle line 52. In contrast, if only a single bed knife was formed from each steel sheet there would be more wasted material throughout the manufacturing process, especially during the welding process. When manufacturing a single bed knife from a single sheet of base material, extra welding material is required at the leading edge where the cutting portion is to be formed. In addition, the edge will have a high heat concentration during the welding process causing the edge to be susceptible to the welding material melting over. These problems are avoided by applying the weld bead to the middle portion of the sheet 34 first, and then cutting the sheet 34 through the crown 48 to form two leading edges 62 of two separate bed knives 22. Therefore, forming two bed knives from a single sheet 34 is advantageous over manufacturing one bed knife at a time.

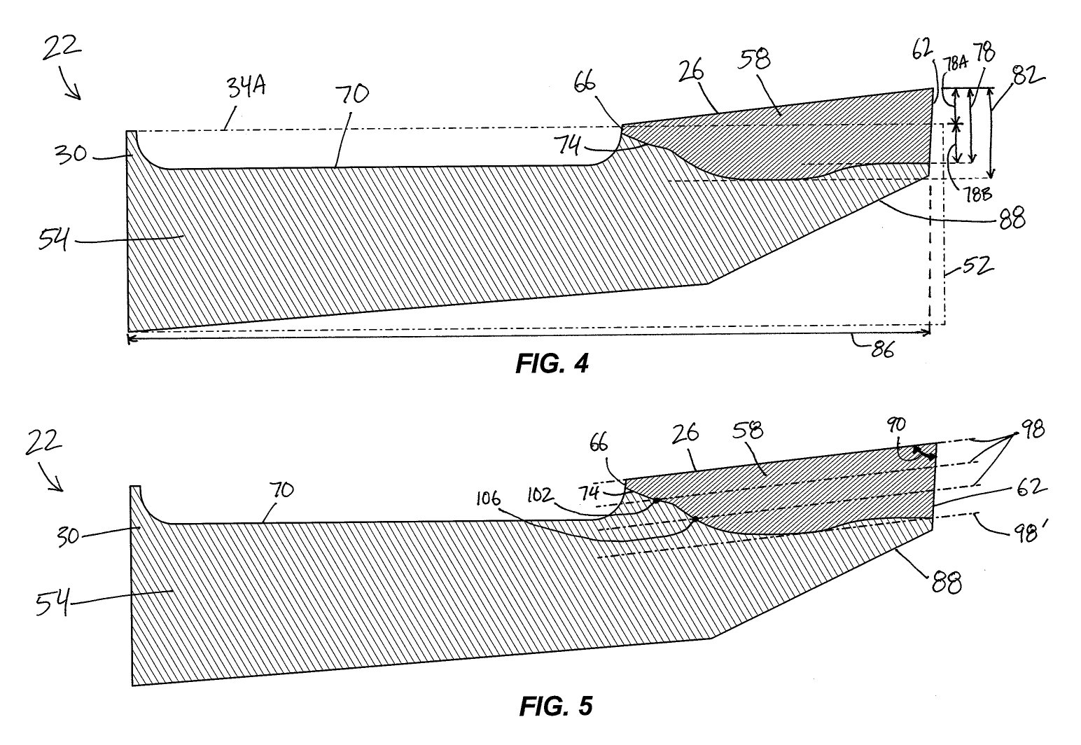

With reference to FIG. 4, one of the resulting sheet halves 34A from FIG. 2D is formed into the final bed knife 22 geometry shown in cross-section in FIG. 4. For reference, the original sheet half 34A material area (i.e., half of the original first material) is shown in phantom lines. The first material is machined away, and the second material is ground to dimension with grinding stones. Following the formation of the bed knife 22 into the final geometry (which will be discussed in greater detail below), the bed knife 22 can be heat-treated to increase strength and hardness of the first material, as desired. Heat-treating the bed knife 22 after the final geometry has been formed improves the yield strength of the bed knife 22 and does not negatively affect a weld interface 74 defined between the first material and the second material. Heat-treating a bed knife after the final geometry has been formed is less advantageous for bed knives with brazed inserts, because heat treating the brazing material weakens the bond strength between the insert and the base material. Therefore, if bed knives with brazed inserts are heat treated after the final geometry is formed, the brazed interface would be compromised. On the other hand, if bed knives with brazed inserts are heat treated before the insert is brazed onto the knife body, a heat-affected-zone with weaker material properties would be created when the insert is brazed into place after heat treatment.

The final geometry of the bed knife 22 includes a body 54 formed of the first material, and a cutting portion 58 formed of the second material. The cutting portion 58 includes the cutting surface 26 defined by a leading edge 62 and a trailing edge 66. The body 54 includes a cutout portion 70 between the trailing edge 66 of the cutting portion 58 and the mounting portion 30. The weld interface 74 includes different dilution depths (i.e., the second material extends into the first material a first depth 78 at the leading edge 62, and the second material extends into the first material a second depth 82 at a point between the leading edge 62 and the trailing edge 66). The first depth 78 is less than the second depth 82, and first depth 78 consists of two components: a top depth component 78A and a bottom depth component 78B. The top depth component 78A is the distance the cutting portion 58 extends above the original sheet 34 (FIG. 4, shown in phantom), and the bottom depth component 78B is the distance the cutting portion 58 extends into the original sheet 34. The top depth component 78A is greater than approximately 70% of the bottom depth component 78B.

The cutting portion 58 is supported by the body 54 along an entire length 86 of the bed knife 22. Accordingly, the bed knife 22 is more resistant to damage from impact since the cutting portion 58 is fully supported by the body 54 and is not cantilevered. The first depth 78 is shallower than the second depth 82, so that the first material is supporting the entire cutting portion 58. A surface 88 under the cutting portion 58 consists entirely of a single material (i.e., the first material) which makes machining the surface 88 into the final geometry easier. In other words, if the surface 88 consisted of both the first and second materials, the manufacturing would include machining for the softer, first material and grinding for the harder, second material. Additionally, there are no stress concentrations between the cutting portion 58 and the body 54, unlike other bed knives with inserts brazed into cutouts. In typical constructions, tool steel inserts are brazed onto a bed knife, but the brazed joints contain less strength along the interface than the present invention, resulting in the brazed bed knives being more susceptible to failure under high impact conditions.

With reference to FIG. 5, the leading edge 62 and the cutting surface 26 define therebetween an acute angle 90. The angle 90 can be, for example, approximately 60 degrees to 89 degrees. The bed knife 22 is subject to wear and once the cutting portion 58 has dulled, the bed knife 22 can be re-sharpened to renew the angle 90 to the cutting portion 58. Lines of re-sharpening 98 are generally indicated in FIG. 5. These re-sharpening lines 98 are generally parallel to the original cutting surface 26 and, advantageously, are also generally parallel to a line 98′ extending between a point at the deepest part of the weld interface 74 and a point at the leading edge 62 of the weld interface 74. This particular varied dilution depth, which is selectively achieved by controlling the welding operation to achieve the weld interface 74 geometry generally defining the line 98′, allows the user to re-sharpen the cutting portion 58 a greater number of times, thereby increasing the life of the bed knife 22.

Additionally, as the cutting portion 58 wears and re-sharpening takes place, the second material will wear away from and/or be intentionally removed from the first material at the trailing edge 66, exposing more and more of the first material underneath (i.e., the trailing edge 66 of the second material moves toward the leading edge 62 as the cutting portion 58 wears/is re-sharpened). By observing and/or tracking where the trailing edge 66 of the second material is in relation to the leading edge 62 at any given point in the life of the bed knife 22, a wear indication or remaining life indication can be provided to the user. For example, the different locations of points 102 and 106 relative to the leading edge 62 in FIG. 5 can illustrate to a user the remaining useful life (i.e., the number of re-sharpenings that can still be performed) of the bed knife 22.

Various features and advantages of the invention are set forth in the following claims.

What is claimed is:

1. A bed knife adapted to be coupled with a reel cutting unit for cutting grass and oriented with respect to a rotating cutting reel of the reel cutting unit, the bed knife comprising:
a body formed from a first material; and
a cutting portion formed from a second material, the second material different from the first material;
wherein the second material is deposited onto the body by a welding process.

2. The bed knife of claim 1, wherein the second material is deposited onto the body with different dilution depths along the cutting portion.

3. The bed knife of claim 2, wherein the dilution depth is a maximum between a leading edge of the cutting portion and a trailing edge of the cutting portion.

4. The bed knife of claim 1, wherein a cutting surface of the cutting portion and a leading edge of the cutting portion form an acute angle.

5. The bed knife of claim 4, wherein a welding interface between the first material and the second material is substantially parallel to the cutting surface.

6. The bed knife of claim 1, wherein the cutting portion is supported by the body from a leading edge of the cutting portion to a trailing edge of the cutting portion

7. The bed knife of claim 1, wherein the second material is harder than the first material.

8. The bed knife of claim 1, wherein the second material is removed from a trailing edge of the cutting portion to expose the first material as the bed knife wears.

9. The bed knife of claim 1, wherein the cutting portion defines a depth at a leading edge of the cutting portion, the depth includes a first depth component defined by the distance the cutting portion extends above the body, and a second depth component defined by the distance the cutting portion extends into the body.

10. The bed knife of claim 9, where the first depth component is at least 70% of the second depth component.

11. A method of manufacturing a bed knife adapted to be coupled with a reel cutting unit for cutting grass and oriented with respect to a rotating cutting reel of the reel cutting unit, the method comprising:
providing a sheet formed from a first material;
depositing a second material onto the first material by a welding process;
machining away portions of the first material and the second material to form the bed knife.

12. The method of claim 11, wherein depositing the second material onto the first material includes depositing the second material to achieve different dilution depths of the second material into the first material.

13. The method of claim 12, wherein the different dilution depths are controlled by a speed of the welding process.

14. The method of claim 12, wherein the different dilution depths are controlled by a weave pattern used in the welding process.

15. The method of claim 11, further comprising separating the sheet with a cutting process, the cutting process including cutting through a location on the sheet containing both the first material and the second material.

16. The method of claim 15, wherein the cutting process is a water-jet cutting process.

17. The method of claim 11, wherein machining away portions of the second material includes creating an acute angle between a cutting surface and a leading edge of the second material.

18. The method of claim 17, wherein a welding interface between the first material and the second material is substantially parallel to the cutting surface.

19. The method of claim 11, wherein machining away portions of the first material includes leaving a portion of the first material under the second material from a leading edge of the second material to a trailing edge of the second material.

20. The method of claim 11, wherein the welding process is a plasma transferred arc welding process.

21. The method of claim 11, wherein the welding process is a laser-cladding welding process.

22. The method of claim 21, wherein depositing the second material onto the first material includes depositing the second material to achieve different dilution depths of the second material into the first material, and wherein the different dilution depths are controlled by a laser intensity of the welding process.

23. The method of claim 11, further comprising heat-treating the bed knife after machining away portions of the first material and the second material to form the bed knife.
